(19) United States
(12) Patent Application Publication
(10) Pub. No.: US 2014/0301909 A1
(43) Pub. Date: Oct. 9, 2014

(54) System and Method for ZPGM Catalytic Converters

(71) Applicant: Zahra Nazarpoor, Camarillo, CA (US)

(72) Inventor: Zahra Nazarpoor, Camarillo, CA (US)

(73) Assignee: CDTi, Ventura, CA (US)

(21) Appl. No.: 13/856,904

(22) Filed: Apr. 4, 2013

(51) Int. Cl. B01D 53/94

(52) U.S. Cl. CPC B01D 53/945
USPC 422/177

(57) ABSTRACT

Compositions and methods for the preparation of ZPGM oxidation catalytic converters are disclosed. ZPGM catalyst systems may be employed within catalytic converters under lean hydrocarbon, air to fuel ratio condition to oxidize toxic gases, such as carbon monoxide and other hydrocarbons that may be included in exhaust gas. ZPGM oxidation catalyst systems are completely free of PGM catalyst and may include: a substrate, a washcoat, and an overcoat. Washcoat may include silver as ZPGM catalyst, and carrier material oxides. Similarly, overcoat may include at least one ZPGM catalyst, carrier material oxides and OSMs. Overcoat of the disclosed ZPGM catalyst system may include copper and cerium as ZPGM catalysts. Suitable known in the art chemical techniques, deposition methods and treatment systems may be employed in order to form the disclosed ZPGM catalyst systems. ZPGM catalyst systems may include high surface area, low conversion temperature catalysts that may exhibit high efficiency in the conversion of exhaust gases

### CROSS-REFERENCE TO RELATED APPLICATIONS

N/A

### BACKGROUND

1. Technical Field

This disclosure relates generally to catalytic converters, more particularly, to zero platinum group metals catalytic converters.

2. Background Information

Emission standards for unburned contaminants, such as hydrocarbons, carbon monoxide and nitrogen oxide, continue to become more stringent. In order to meet such standards, oxi-catalysts and three-way catalysts (TWC) are used in the exhaust gas lines of internal combustion engines. These catalysts promote the oxidation of unburned hydrocarbons and carbon monoxide as well as the reduction of nitrogen oxides in the exhaust gas stream. One of the major limitations of current catalytic converters is that the PGM materials used in their fabrication have very high demand and increasing prices.

Therefore, there is a continuing need to provide cost effective oxidation and three-way catalysts that provide sufficient conversion so that HC, NOx, and CO emission standards can be achieved, minimizing the amount of catalysts required.

### SUMMARY

ZPGM catalytic converters are disclosed. The ZPGM catalytic converters may oxidize toxic gases, such as carbon monoxide, hydrocarbons and nitrogen oxides. ZPGM catalyst converters may include: a substrate, a washcoat, and an overcoat. Washcoat and overcoat may include at least one ZPGM catalyst, carrier material oxides and OSMs. Suitable known in the art chemical techniques, deposition methods and treatment systems may be employed in order to form the disclosed ZPGM catalytic converters.

Materials suitable for use as catalyst include Copper (Cu), Cerium (Ce), Silver (Ag), Tin (Sn), Niobium (Nb), Zirconium (Zr), Lanthanum (La), Iron (Fe), Cobalt (Co), Manganese (Mn), Calcium (Ca) and combinations thereof.

Catalytic converters that include combinations of Cu, Ce and Ag in the washcoat or overcoat may be suitable for use as Oxidation Catalysts at temperatures below 300° C.

Suitable materials for use as substrates may include refractive materials, ceramic materials, metallic alloys, foams, microporous materials, zeolites, cordierites, or combinations.

Support materials of use in catalysts containing one or more of the aforementioned combinations may include Cerium Oxide, Alumina, Titanium Oxide, Zirconia, and combinations thereof.

Suitable known in the art chemical techniques, deposition methods and treatment systems may be employed in order to form the disclosed ZPGM catalyst converters.

Numerous other aspects, features and advantages of the present disclosure may be made apparent from the following detailed description, taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, reference numerals designate corresponding parts throughout the different views.

FIG. 1 shows a catalyst system structure, according to an embodiment.

FIGS. 2A-D illustrates substrate structures, according to an embodiment.

FIG. 3 is a flowchart of a method of preparing a ZPGM catalyst system, according to an embodiment.

FIG. 4 shows light-off test results of a ZPGM catalyst system, according to an embodiment.

FIG. 5 shows light-off test results of a ZPGM catalyst system, according to an embodiment.

FIG. 6 shows light-off test results of a ZPGM catalyst system, according to an embodiment.

FIG. 7 shows light-off test results of a ZPGM catalyst system, according to an embodiment.

FIG. 8 shows light-off test results of a ZPGM catalyst system, according to an embodiment.

FIG. 9 shows light-off test results of a ZPGM catalyst system, according to an embodiment.

FIG. 10 shows light-off test results of ZPGM catalyst systems, according to an embodiment

FIG. 11 shows a bar graph of washcoat adhesion loss in ZPGM catalyst systems, according to an embodiment.

### DETAILED DESCRIPTION

The present disclosure is here described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

### DEFINITIONS

As used here, the following terms have the following definitions:

“Complexing agent” refers to a substance capable of promoting the formation of complex compounds.

“Exhaust” refers to the discharge of gases, vapor, and fumes including hydrocarbons, nitrogen oxide, and/or carbon monoxide.

“Impregnation” refers to the process of totally saturating a solid layer with a liquid compound.

“Wash-coat” refers to at least one coating including at least one oxide solid that may be deposited on a substrate.

“Over-coat” refers to at least one coating including one or more oxide solids or metals that may be deposited on at least one wash-coat or impregnation layer.

“R Value” refers to the number obtained by dividing the reducing potential by the oxidizing potential.

“Rich Exhaust” refers to exhaust with an R value above 1.

“Lean Exhaust” refers to exhaust with an R value below 1.

“Conversion” refers to the chemical alteration of at least one material into one or more other materials.

“T50” refers to the temperature at which 50% of a material is converted.

“T90” refers to the temperature at which 90% of a material is converted.

“Three Way Catalyst (TWC)” refers to a catalyst suitable for use in converting at least hydrocarbons, nitrogen oxide, and carbon monoxide.

“Oxidation Catalyst” refers to a catalyst suitable for use in converting at least hydrocarbons and carbon monoxide.

“Zero Platinum Group (ZPGM) Catalyst” refers to a catalyst completely or substantially free of platinum group metals.

“Platinum Group Metals (PGMs)” refers to platinum, palladium, ruthenium, iridium, osmium, and rhodium.

### DESCRIPTION OF THE DRAWINGS

System Configuration and Composition

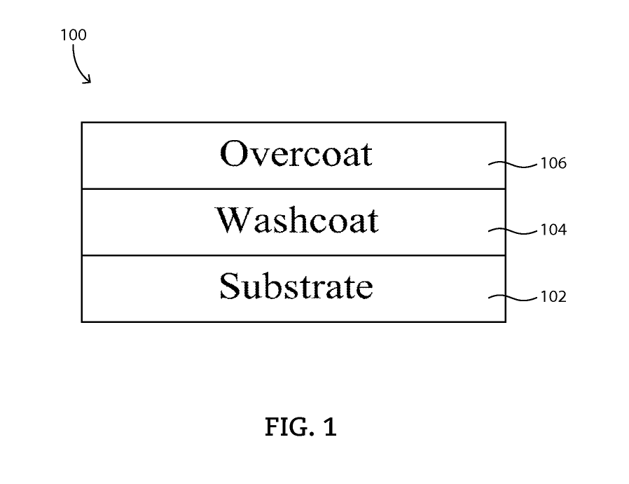

FIG. 1 depicts ZPGM catalyst system 100 configurations, according to various embodiments. As shown in FIG. 1 A, ZPGM catalyst system 100 may include at least a Substrate 102 and a Washcoat 104, where Washcoat 104 may contain active two way or three way ZPGM catalyst components. ZPGM catalyst system 100 may optionally include an Overcoat 106 applied on over of Washcoat 104. Where Washcoat 104 or Overcoat 106, or both, may include active two way or three way ZPGM catalyst components.

According to an embodiment, Washcoat 104 or Overcoat 106 or both may include at least one ZPGM transition metal catalyst, a ZPGM mixed metal catalyst, a ZPGM zeolite catalyst, or combinations thereof. A ZPGM transition metal catalyst may include one or more transition metals and/or least one rare earth metal, or a mixture; excluding platinum group metals.

According to an embodiment, a ZPGM catalyst system 100 may include a ZPGM transition metal catalyst. The ZPGM transition metal catalyst may include at least silver oxide and copper oxide distributed in Washcoat 104 or Overcoat 106, or in both. In addition to copper and silver, the ZPGM transition metal catalyst may include one or more transition metals that are completely free of platinum group metals. ZPGM transition metal catalyst may include scandium, titanium, chromium, manganese, iron, cobalt, nickel, zinc, yttrium, zirconium, niobium, molybdenum, cadmium, hafnium, tantalum, tungsten, rhenium and gallium. In some embodiments, nickel, iron, manganese and cobalt may be preferably added to ZPGM catalyst system 100. Furthermore, ZPGM catalyst system 100 may optionally include rare earth metals or rare earth metal oxides, e.g., ceria.

Additionally, Washcoat 104 or Overcoat 106, or both, may include support oxides material referred to as carrier material oxides. Carrier material oxides may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. In some embodiments, carrier material oxides may be doped with one or more lanthanides.

In some embodiments, ZPGM catalyst system 100 may include alumina mixed with other metals.

Carrier material oxide may be present in Washcoat 104 in a ratio of about 40 to about 60 by weight. Carrier material oxides are normally inert and stable at high temperatures (>1000° C.) and under a range of reducing and oxidizing conditions.

In other embodiments, Washcoat 104 or Overcoat 106, or both, may include oxygen storage materials (OSM), such as cerium, zirconium, lanthanum, yttrium, lanthanides, actinides, and mixtures thereof.

In some embodiments, Washcoat 104 may also include other components such as acid or base solutions or various salts or organic compounds that may be added in order to adjust rheology of the Washcoat 104 and Overcoat 106 slurry and to enhance the adhesion of Washcoat 104 to substrate 102. Some examples of compounds that can be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol and other suitable compounds. Preferred solution to enhance binding of Washcoat 104 to Substrate 102 may be tetraethyl ammonium hydroxide.

In other embodiments, other components known to one of ordinary skill in the art may be included in Washcoat 104 or Overcoat 106.

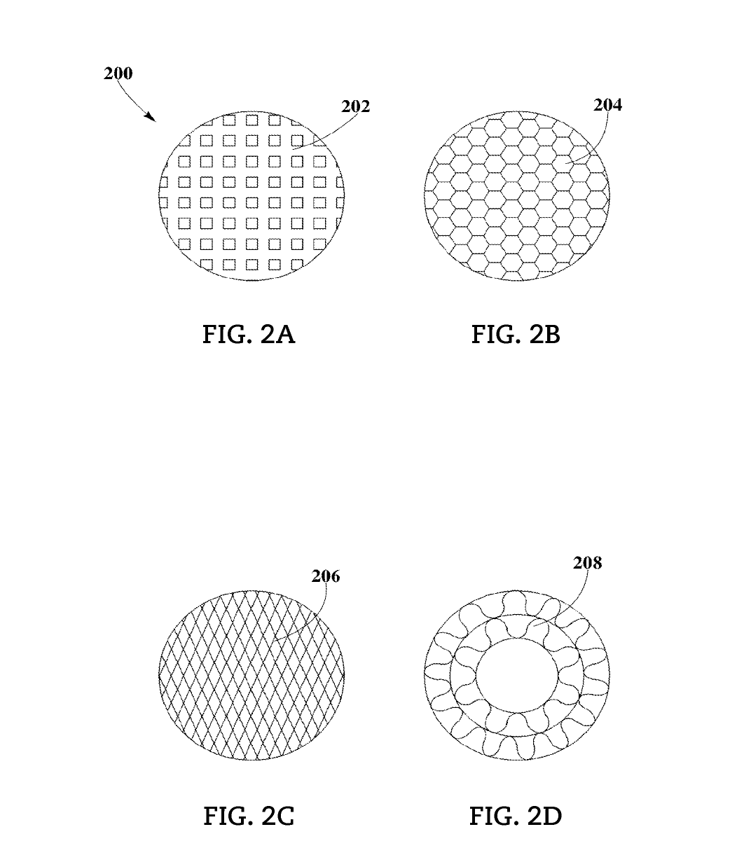

FIGS. 2A-D illustrates examples of Substrate structures 200, according to various embodiments. FIG. 2 A shows Substrate 102 with a Square pattern 202. FIG. 2 B illustrates a Substrate 102 with a Honeycomb structure 204. FIG. 2 C shows a Substrate 102 with a Diamond shaped pattern 206 and FIG. 2 D shows a Sinusoidal wave 208 patterned Substrate 102. The Substrates 102 may display other patterns suitable to be used as oxidation or three way catalyst converters. According to an embodiment the catalyst converter may have a plurality of flow channels extending through its length in similar arrangements to the ones disclosed in FIGS. 2A, 2B, 2C and 2D. In some embodiments the Substrate 102 may be shaped in form of a filter, for example a wall flow-through filter, having suitable porosity. Suitable materials for Substrate 102 may include refractive materials, ceramic materials, metallic alloys, foams, microporous materials, zeolites, cordierites, mullite, or combinations. Specific compositions, sizes, volumes and cell densities of Substrate 102 may vary according to the specifics of each application.

Methods of Preparation of Washcoat and Overcoat

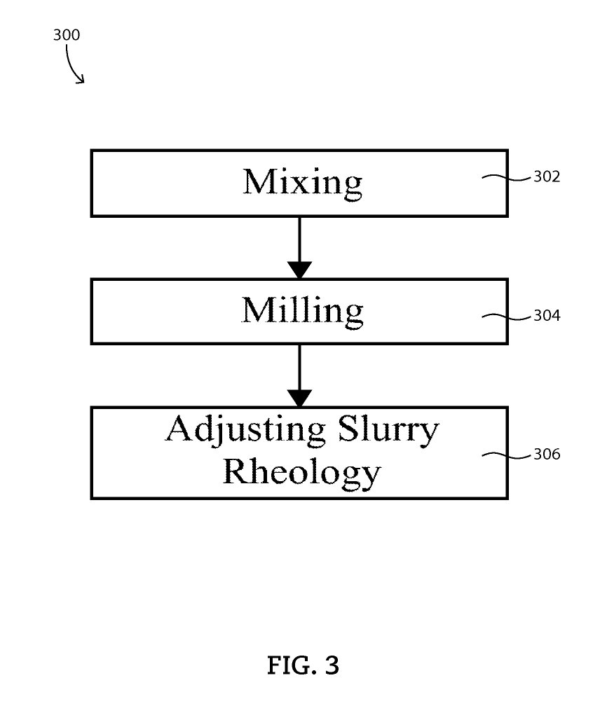

FIG. 3 is a flowchart of Method for preparation 300 of Washcoat 104 and Overcoat 106, according to an embodiment.

According to the present disclosure, Washcoat 104 or Overcoat 106 may be prepared by following Method for preparation 300. In an embodiment, Method for preparation 300 may be a “co-milling method” which may begin with a Mixing 302 process. In this process, components of Washcoat 104 or Overcoat 106, previously described, may be mixed together. Subsequently, the mixture may undergo a Milling process 304 in which Washcoat 104 or Overcoat 106 materials may be broken down into smaller particle sizes. After milling process 304, a catalyst aqueous slurry may be obtained. Milling process 304 may take from about 10 minutes to about 10 hours, depending on the batch size, kind of material and particle size desired. In one embodiment of the present disclosure, suitable average particle size (APSs) of the slurry may be of about 4 microns to about 10 microns, in order to get uniform distribution of Washcoat 104 particles or Overcoat 106 particles. Finer particles may have more coat ability and better adhesion to Substrate 102 and enhanced cohesion between Washcoat 104 and Overcoat 106 layers. Milling process 304 may be achieved by employing any suitable mill such as vertical or horizontal mills. In order to measure exact particle size desired during Milling process 304, a laser light diffraction equipment may be employed. In order to further enhance coatability and binding properties of Washcoat 104 and Overcoat 106, aqueous slurries obtained in Milling process 304 may undergo an Adjusting rheology 306 step. In Adjusting rheology 306 step, acid or base solutions or various salts or organic compounds may be added to the aqueous slurries. Some examples of compounds that can be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol and other suitable compounds. All steps included in Method for preparation 300 may be achieved within room temperature.

In the preparation of ZPGM catalyst system 100 including a substrate 102, a Washcoat 104 and an Overcoat 106, Washcoat 104 may be deposited on Substrate 102 in at least three different ways. First, depositing all desired components in one step. Or second, by depositing components without a catalyst, then separately depositing at least one impregnation component and heating (this separate deposit is also referred to as an impregnation step). The impregnation component may include, without limitation, transition metals, alkali and alkaline earth metals, cerium, lanthanum, yttrium, lanthanides, actinides, or mixtures thereof. During the impregnation step, metal salts may be converted into metal oxides creating a Washcoat 104 that includes at least a catalyst. The third method includes depositing all desired components of Washcoat 104 at once, including metal salts and then heating or calcining ZPGM catalyst system 100 to convert the metals salts into metal oxides. An Overcoat 106 may be typically applied after treating Washcoat 104, but treating is not required prior to application of Overcoat 106 in every embodiment.

Various amounts of any of the washcoats 104 may be coupled with a substrate 102, preferably an amount that covers most of, or all of, the surface area of a substrate 102. In an embodiment, about 60 g/L to about 250 g/L of a Washcoat 104 may be coupled with a substrate 102.

In an embodiment, a Washcoat 104 may be formed on the Substrate 102 by suspending the oxide solids in water to form an aqueous slurry and depositing the aqueous slurry on Substrate 102 as a Washcoat 104. Other components may optionally be added to the aqueous slurry. Other components such as acid or base solutions or various salts or organic compounds may be added to the aqueous slurry to adjust the rheology of the slurry and enhance binding of the Washcoat 104 to the substrate 102.

The slurry may be placed on Substrate 102 in any suitable manner. For example, Substrate 102 may be dipped into the slurry, or the slurry may be sprayed on substrate 102. Other methods of depositing the slurry onto Substrate 102 known to those skilled in the art may be used in alternative embodiments. If Substrate 102 is a monolithic carrier with parallel flow passages, a Washcoat 104 may be formed on the walls of the passages.

In other embodiments, Washcoat 104 and Overcoat 106 may be synthesized by any chemical techniques known in the art.

### Examples

In example 1, a ZPGM catalyst system 100 including a ZPGM transition metal catalyst having a metallic substrate 102, a Washcoat 104 and an Overcoat 106 is prepared. The Washcoat 104 includes at least silver, and a carrier material oxide such as alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The copper and cerium in Overcoat 106 are present in about 5% to about 50% by weight or from about 10% to 16% by weight of Cu and 12% to 20% by weight of Ce. To prepare the ZPGM catalyst system 100 of example 1, the transition metal (silver) and a carrier material oxide are milled together. The catalyst can be synthesized by any suitable chemical technique known in the art. The milled mixture of catalyst and carrier material oxides is deposited on the metallic Substrate 102 in the form of a Washcoat 104 and then heat treated. This treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Washcoat 104 on Substrate 102 is of about 100 g/L. The Overcoat 106 is prepared following a similar method and the total solid loading of Overcoat 106 is 80 g/L.

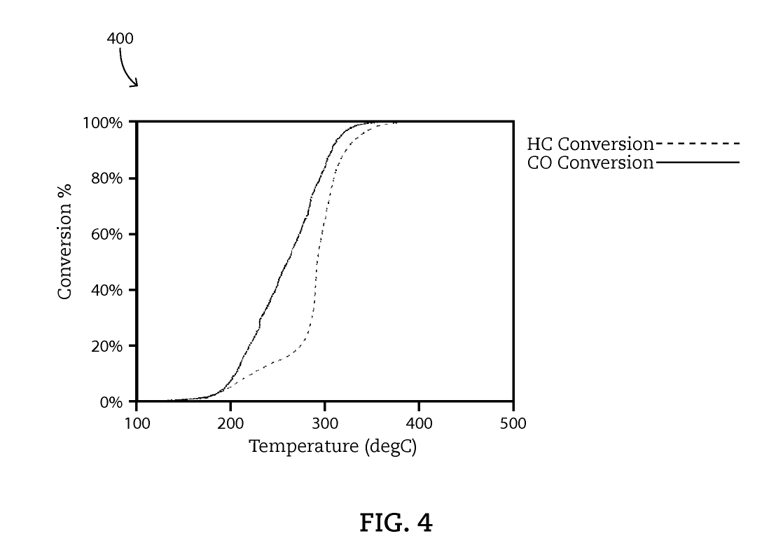

FIG. 4 shows Light-off test results 400 of the ZPGM catalyst system 100 of example 1. Prior to the light off test, the ZPGM catalyst system 100 of example 1 is aged under dry air condition at 900° C. for 4 hours. The hydrocarbon present in the feed stream is toluene. Carbon monoxide, and hydrocarbons conversion are measured as a function of the ZPGM catalyst system 100 temperature. Since the light-off test is performed under lean condition (R-values<1), no nitrogen oxide conversion is measured. The test is performed by increasing the temperature from about 100° C. to 500° C. at a constant rate of 40° C./min. The light-off test at R=0.633 shows that the ZPGM catalyst system 100 of example 1 has a T50 for CO of 284° C. and a T50 for HC of 342° C.

In example 2, a ZPGM catalyst system 100 including a ZPGM transition metal catalyst having a cordierite substrate 102, a Washcoat 104 and an Overcoat 106 is prepared. The Washcoat 104 includes at least silver, and a carrier material oxide such as alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The alumina in Overcoat 106 is doped with about 4% lanthanum. The copper and cerium in Overcoat 106 are present in about 5% to about 50% by weight or from about 10% to 16% by weight of Cu and 12% to 20% by weight of Ce. To prepare the ZPGM catalyst system 100 of example 2, the transition metal (silver) and a carrier material oxide are milled together. The catalyst can be synthesized by any suitable chemical technique known in the art. The milled mixture of catalyst and carrier material oxides is deposited on the cordierite Substrate 102 in the form of a Washcoat 104 and then heat treated. This treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Washcoat 104 on Substrate 102 is of about 100 g/L. The Overcoat 106 is prepared following a similar method and the total solid loading of Overcoat 106 is 80 g/L.

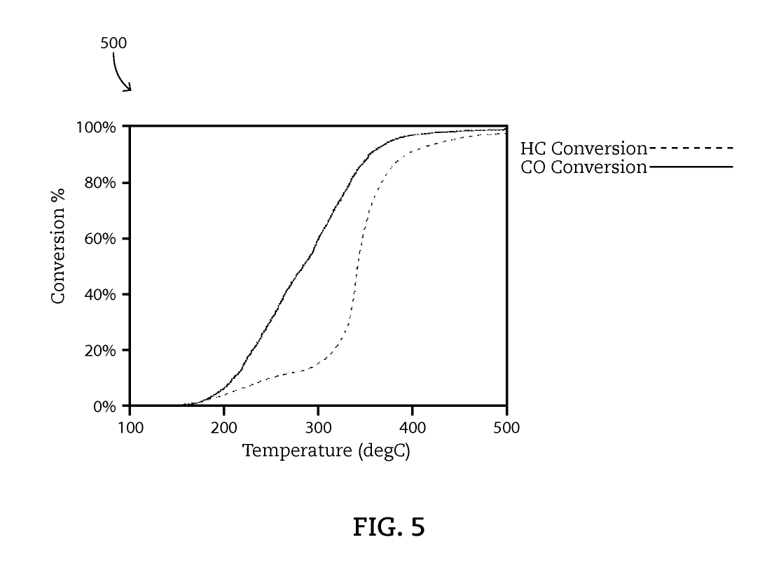

FIG. 5 shows Light-off test results 500 of the ZPGM catalyst system 100 of example 2. Prior to the light off test, the ZPGM catalyst system 100 of example 2 is aged under dry air condition at 900° C. for 4 hours. The hydrocarbon present in the feed stream is toluene. Carbon monoxide, and hydrocarbons conversion are measured as a function of the ZPGM catalyst system 100 temperature. Since the light-off test is performed under lean condition (R-values<1), no nitrogen oxide conversion is measured. The test is performed by increasing the temperature from about 100° C. to 500° C. at a constant rate of 40° C./min. The light-off test at R=0.633 shows that the ZPGM catalyst system 100 of example 2 has a T50 for CO of 259° C. and a T50 for HC of 291° C. Note that the T50 for both HC and CO conversion are lower for ZPGM catalyst system 100 of example 2.

In example 3, a ZPGM catalyst system 100 including a ZPGM transition metal catalyst having a metallic substrate 102, a Washcoat 104 and an Overcoat 106 is prepared. The Substrate 102 is cylindrical, has a diameter of 40 mm, a length of 60 mm, a cell desity of 300 cpsi and a volume of 0.0754 L. The Washcoat 104 includes at least silver, and a carrier material oxide such as alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The alumina in Overcoat 106 is doped with about 4% lanthanum. The copper and cerium in Overcoat 106 are present in about 5% to about 50% by weight or from about 10% to 16% by weight of Cu and 12% to 20% by weight of Ce. To prepare the ZPGM catalyst system 100 of example 3, the transition metal (silver) and a carrier material oxide are milled together. The catalyst can be synthesized by any suitable chemical technique known in the art. The milled mixture of catalyst and carrier material oxides is deposited on the metallic Substrate 102 in the form of a Washcoat 104 and then heat treated. This treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Washcoat 104 on Substrate 102 is of about 100 g/L. The Overcoat 106 is prepared following a similar method and the total solid loading of Overcoat 106 is 80 g/L.

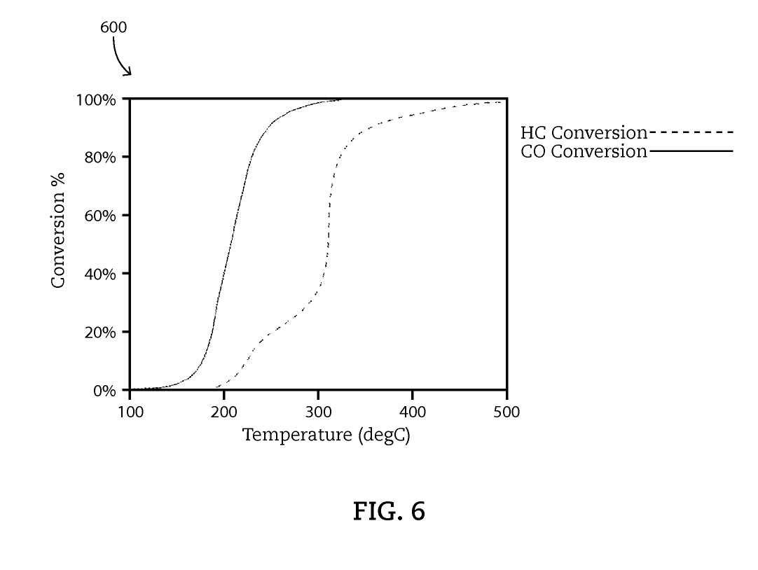

FIG. 6 shows Light-off test results 600 of a fresh sample of the ZPGM catalyst system 100 of example 3. Carbon monoxide, and hydrocarbons conversion are measured as a function of the ZPGM catalyst system 100 temperature. The hydrocarbon present in the feed stream is toluene. Since the light-off test is performed under lean condition (R-values<1), no nitrogen oxide conversion is measured. The test is performed by increasing the temperature from about 100° C. to 500° C. at a constant rate of 40° C./min. The light-off test at R=0.633 shows that the ZPGM catalyst system 100 of example 3 has a T50 for CO of 206° C. and a T50 for HC of 301° C.

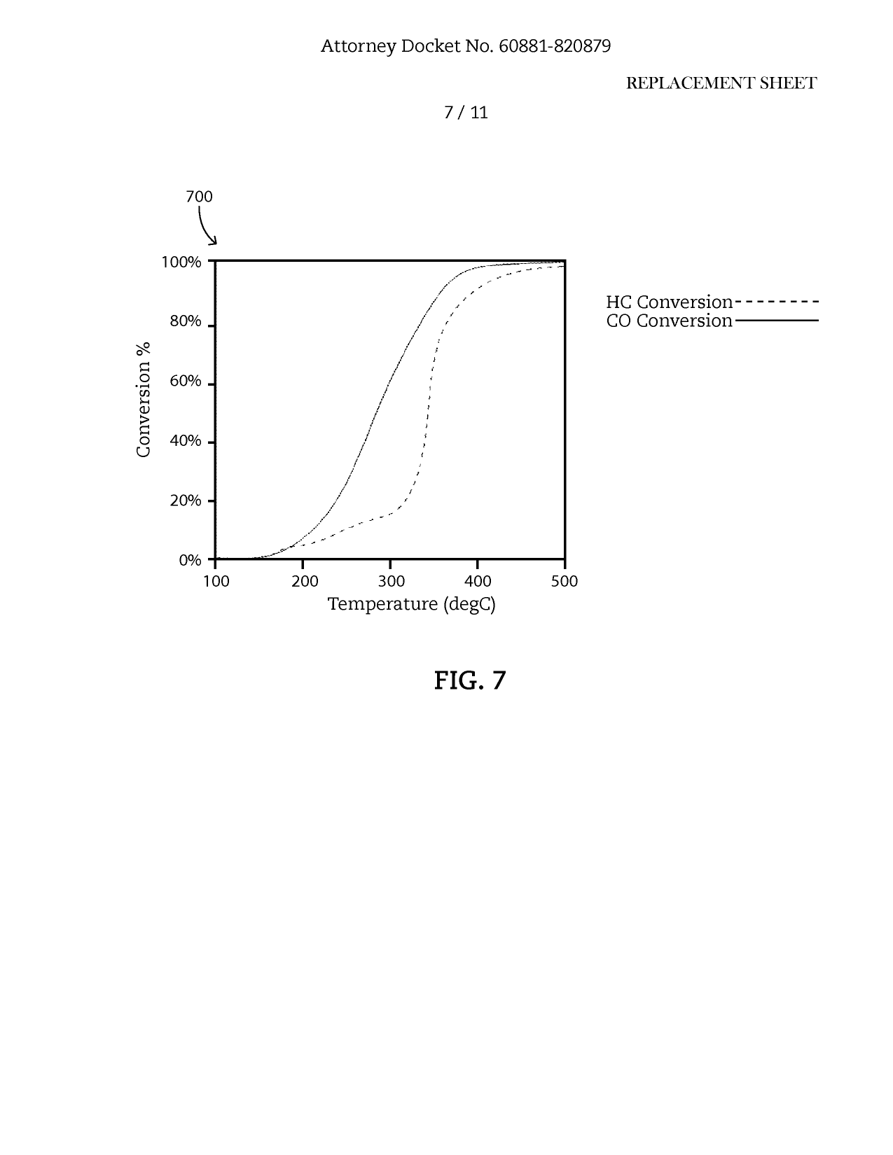

FIG. 7 shows Light-off test results 700 the ZPGM catalyst system 100 of example 3. Prior to the light off test, the ZPGM catalyst system 100 of example 3 is aged under dry air condition at 900° C. for 4 hours. The hydrocarbon present in the feed stream is toluene. Carbon monoxide, and hydrocarbons conversion are measured as a function of the ZPGM catalyst system 100 temperature. Since the light-off test is performed under lean condition (R-values<1), no nitrogen oxide conversion is measured. The test is performed by increasing the temperature from about 100° C. to 500° C. at a constant rate of 40° C./min. The light-off test at R=0.633 shows that the ZPGM catalyst system 100 of example 3 has a T50 for CO of 284° C. and a T50 for HC of 342° C.

In example 4, a ZPGM catalyst system 100 including a ZPGM transition metal catalyst having a metallic substrate 102, a Washcoat 104 and an Overcoat 106 is prepared. The Substrate 102 is cylindrical, has a diameter of 40 mm, a length of 60 mm, a cell desity of 100 cpsi and a volume of 0.0754 L. The Washcoat 104 includes at least silver, and a carrier material oxide such as alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The alumina in Overcoat 106 is doped with about 4% lanthanum. The copper and cerium in Overcoat 106 are present in about 5% to about 50% by weight or from about 10% to 16% by weight of Cu and 12% to 20% by weight of Ce. To prepare the ZPGM catalyst system 100 of example 4, the transition metal (silver) and a carrier material oxide are milled together. The catalyst can be synthesized by any suitable chemical technique known in the art. The milled mixture of catalyst and carrier material oxides is deposited on the metallic Substrate 102 in the form of a Washcoat 104 and then heat treated. This treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Washcoat 104 on Substrate 102 is of about 100 g/L. The Overcoat 106 is prepared following a similar method and the total solid loading of Overcoat 106 is 80 g/L.

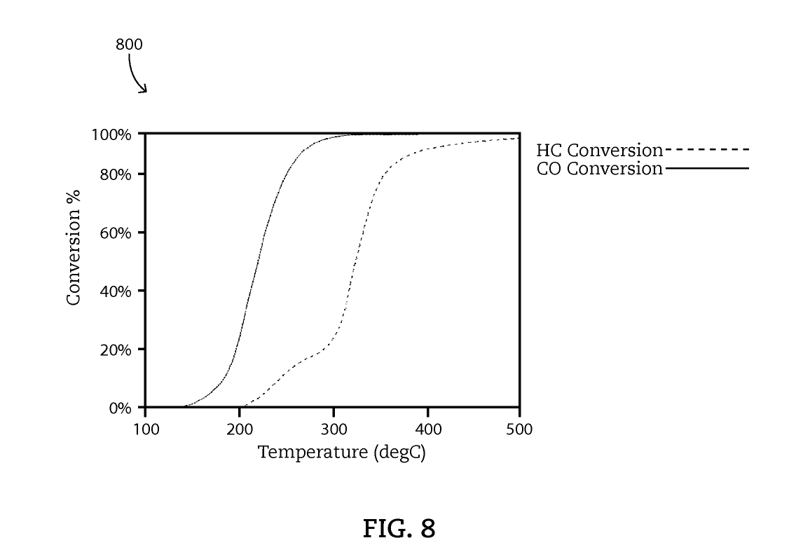

FIG. 8 shows Light-off test results 800 of a fresh sample of the ZPGM catalyst system 100 of example 4. Carbon monoxide, and hydrocarbons conversion are measured as a function of the ZPGM catalyst system 100 temperature. The hydrocarbon present in the feed stream is toluene. Since the light-off test is performed under lean condition (R-values<1), no nitrogen oxide conversion is measured. The test is performed by increasing the temperature from about 100° C. to 500° C. at a constant rate of 40° C./min. The light-off test at R=0.633 shows that the ZPGM catalyst system 100 of example 4 has a T50 for CO of 217° C. and a T50 for HC of 323° C.

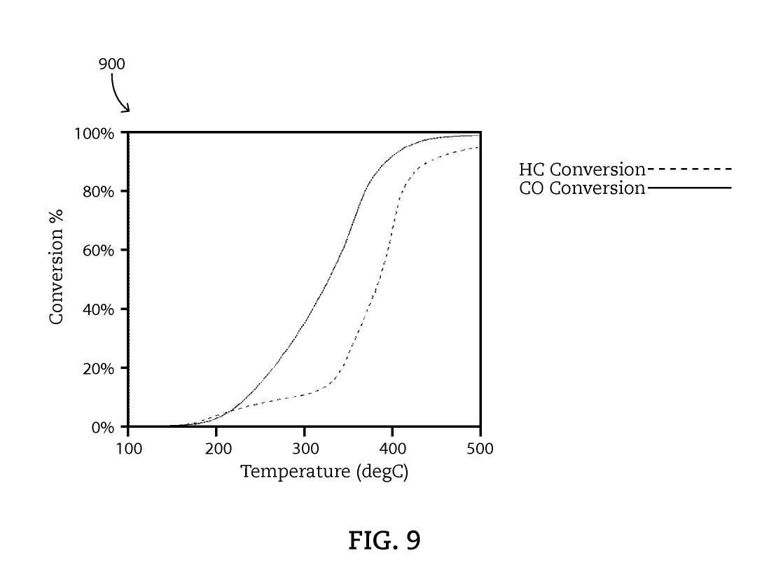

FIG. 9 shows Light-off test results 900 the ZPGM catalyst system 100 of example 4. Prior to the light off test, the ZPGM catalyst system 100 of example 4 is aged under dry air condition at 900° C. for 4 hours. The hydrocarbon present in the feed stream is toluene. Carbon monoxide, and hydrocarbons conversion are measured as a function of the ZPGM catalyst system 100 temperature. Since the light-off test is performed under lean condition (R-values<1), no nitrogen oxide conversion is measured. The test is performed by increasing the temperature from about 100° C. to 500° C. at a constant rate of 40° C./min. The light-off test at R=0.633 shows that the ZPGM catalyst system 100 of example 4 has a T50 for CO of 330° C. and a T50 for HC of 378° C.

In example 5, a ZPGM catalyst system 100 including a ZPGM transition metal catalyst having a metallic substrate 102, a Washcoat 104 and an Overcoat 106 is prepared. The Substrate 102 is cylindrical, has a diameter of 40 mm, a length of 90 mm, a cell desity of 300 cpsi and a volume of 0.113194 L. The Washcoat 104 includes at least silver, and a carrier material oxide such as alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The alumina in Overcoat 106 is doped with about 4% lanthanum. The copper and cerium in Overcoat 106 are present in about 5% to about 50% by weight or from about 10% to 16% by weight of Cu and 12% to 20% by weight of Ce. To prepare the ZPGM catalyst system 100 of example 3, the transition metal (silver) and a carrier material oxide are milled together. The catalyst can be synthesized by any suitable chemical technique known in the art. The milled mixture of catalyst and carrier material oxides is deposited on the metallic Substrate 102 in the form of a Washcoat 104 and then heat treated. This treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Washcoat 104 on Substrate 102 is of about 100 g/L. The Overcoat 106 is prepared following a similar method and the total solid loading of Overcoat 106 is 80 g/L.

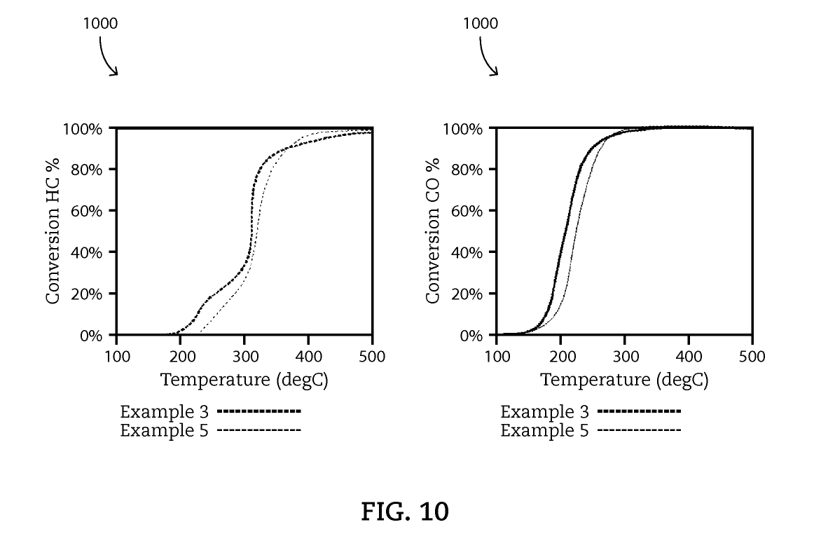

FIG. 10 shows Light-off test results 1000 of fresh samples of the ZPGM catalyst systems 100 of examples 3 and 5. Carbon monoxide, and hydrocarbons conversion are measured as a function of the ZPGM catalyst system 100 temperature. The hydrocarbon present in the feed stream is toluene. Since the light-off test is performed under lean condition (R-values<1), no nitrogen oxide conversion is measured. The test is performed by increasing the temperature from about 100° C. to 500° C. at a constant rate of 40° C./min. The light-off test at R=0.633 shows that the ZPGM catalyst system 100 of example 5 has a T50 for CO of 222° C. and a T50 for HC of 318° C. Which compared with the ZPGM catalyst system 100 of example 3 is 17° C. higher for HC and 15° C. higher for CO.

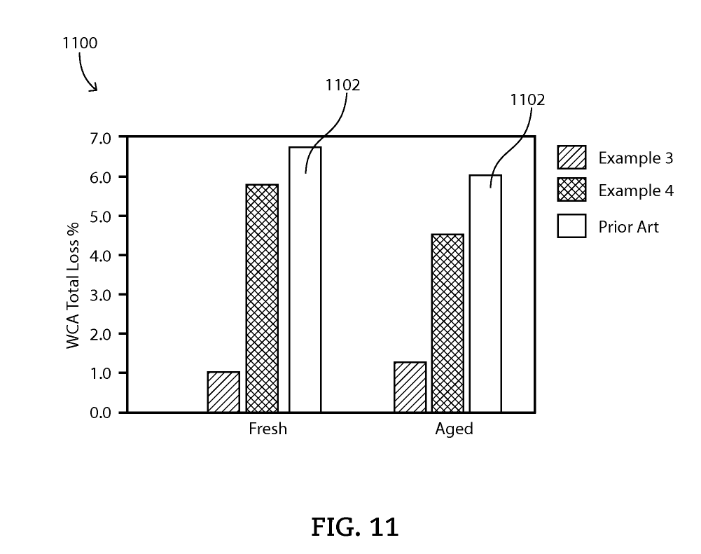

FIG. 11 shows Bar graph 1100, which compares the Washcoat 104 adhesion loss of fresh and aged samples of three different catalyst systems. ZPGM catalyst system 100 of example 3, ZPGM catalyst system 100 of example 4 and a prior art ZPGM catalyst system 1102. Where Prior art ZPGM catalyst system 1102 includes a substrate a washcoat and an overcoat. The washcoat doesn't include transition metals and the overcoat is the same as in examples 3 and 4. As shown in Bar graph 1100, Prior art ZPGM catalyst system 1102 shows higher percentage of Washcoat 104 adhesion loss for both, fresh and aged, samples. The fresh samples of Prior art ZPGM catalyst system 1102 and ZPGM catalyst system 100 of example 4 show higher Washcoat 104 adhesion loss percentage than their respective aged samples. Conversely, fresh sample of ZPGM catalyst system 100 of example 3 shows lower Washcoat 104 adhesion loss than the aged sample. Overall, ZPGM catalyst system 100 of example 3 shows significant lower Washcoat 104 adhesion loss for both, fresh and aged samples.

To calculate the adhesion loss percentage, the following protocol is used:

First, the ZPGM catalyst system 100 is heated in a convection oven at 150° C. 1 to 2 hours, and the weight W₁ is measured after heating. Then, ZPGM catalyst system 100 is heated to 500° C. for 30 minutes. Afterwards, ZPGM catalyst system 100 is quenched in cold water for 8 seconds and it is heated again in convection oven at 150° C. 1 to 2 hours. Then, ZPGM catalyst system 100 is immersed in cold flow of air of about 100 cfm and heated again in convection oven at 150° C. 1 to 2 hours. Following this, weight W₂ is measured and the total Washcoat 104 adhesion loss is calculated using the formula:

$$WCA \% = \frac{{W}_{1} - {W}_{2}}{{W}_{1} - X} \times 100$$

$$X is substrate weight .$$

In example 6, a ZPGM catalyst system 100 including a ZPGM transition metal catalyst having a cordierite substrate 102, a Washcoat 104 and an Overcoat 106 is prepared. The Washcoat 104 includes at least silver, a spinel (as carrier material oxide) and/or alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The copper and cerium in Overcoat 106 are present in about 5% to about 50% by weight or from about 10% to 16% by weight of Cu and 12% to 20% by weight of Ce. To prepare the ZPGM catalyst system 100 of example 6, Washcoat 104 can be synthesized by any suitable chemical technique known in the art, deposited on the cordierite Substrate 102 and then heat treated. The total solid loading of Washcoat 104 on Substrate 102 is of about 120 g/L. The Overcoat 106 is prepared by co-precipitation. Copper and cerium salts are precipitated with at least one suitable compound. Suitable compounds include NH4OH, (NH4)2CO3, tetraethylammonium hydroxide, other tetraalkylammonium salts, ammonium acetate, and ammonium citrate. Subsequently, the precipitated transition metal salts are deposited on a Substrate 102 previously coated with Washcoat 104. ZPGM catalyst system 100 is heat treated, this treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Overcoat 106 is 80 g/L. The ZPGM catalyst system 100 of example 6 is aged in dry air condition at 900° C. for 4 hours. After aging, a light-off test is performed under lean conditions (R=0.611), including toluene in the feed stream. The measured T50 for HC is of about 300° C. and for CO is of about 283° C.

In example 7, a ZPGM catalyst system 100 including a ZPGM transition metal catalyst having a cordierite substrate 102, a Washcoat 104 and an Overcoat 106 is prepared. The Washcoat 104 includes at least silver, a spinel (as carrier material oxide) and/or alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The copper and cerium in Overcoat 106 are present in about 5% to about 50% by weight or from about 10% to 16% by weight of Cu and 12% to 20% by weight of Ce. To prepare the ZPGM catalyst system 100 of example 7, Washcoat 104 can be synthesized by any suitable chemical technique known in the art, deposited on the cordierite Substrate 102 and then heat treated. The total solid loading of Washcoat 104 on Substrate 102 is of about 120 g/L. The Overcoat 106 is prepared by co-precipitation. Copper and cerium salts are precipitated with at least one suitable compound. Suitable compounds include NH4OH, (NH4)2CO3, tetraethylammonium hydroxide, other tetraalkylammonium salts, ammonium acetate, and ammonium citrate. Subsequently, the precipitated transition metal salts are deposited on a Substrate 102 previously coated with Washcoat 104. ZPGM catalyst system 100 is heat treated, this treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Overcoat 106 is 120 g/L. The ZPGM catalyst system 100 of example 7 is aged in dry air condition at 900° C. for 4 hours. After aging, a light-off test is performed under lean conditions (R=0.611), including toluene in the feed stream. The measured T50 for HC is of about 300° C. and for CO is of about 274° C.

In example 8, a ZPGM catalyst system 100 including a ZPGM transition metal catalyst having a cordierite substrate 102, a Washcoat 104 and an Overcoat 106 is prepared. The Washcoat 104 includes at least silver, a spinel (as carrier material oxide) and/or alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The copper and cerium in Overcoat 106 are present in about 5% to about 50% by weight or from about 10% to 16% by weight of Cu and 12% to 20% by weight of Ce. To prepare the ZPGM catalyst system 100 of example 8, Washcoat 104 can be synthesized by any suitable chemical technique known in the art, deposited on the cordierite Substrate 102 and then heat treated. The total solid loading of Washcoat 104 on Substrate 102 is of about 120 g/L. The Overcoat 106 is prepared by co-milling. Copper and cerium salts are milled with the carrier material oxide, alumina and the OSM. After milling the Overcoat 106 is deposited on a Substrate 102 previously coated with Washcoat 104. ZPGM catalyst system 100 is then heat treated, this treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Overcoat 106 is 80 g/L. The ZPGM catalyst system 100 of example 8 is aged in dry air condition at 900° C. for 4 hours. After aging, a light-off test is performed under lean conditions (R=0.611), including toluene in the feed stream. The measured T50 for CO is of about 286° C. and for CO is of about 252° C.

In example 9, a ZPGM catalyst system 100 including a ZPGM transition metal catalyst having a cordierite substrate 102, a Washcoat 104 and an Overcoat 106 is prepared. The Washcoat 104 includes at least silver, a carrier material oxide such as alumina. There is no OSM in Washcoat 104. The Overcoat 106 includes at least copper oxide, ceria, alumina, and one oxygen storage material. The oxygen storage material present in Overcoat 106 is a mixture of cerium, zirconium, neodymium, and praseodymium. The silver in Washcoat 104 is present in about 1% to about 20%, or from about 4% to about 10% by weight. The alumina and oxygen storage material included in Overcoat 106 are present in a ratio of about 60% to about 40% by weight. The copper and cerium in Overcoat 106 are present in about 5% to about 50% by weight or from about 10% to 16% by weight of Cu and 12% to 20% by weight of Ce. To prepare the ZPGM catalyst system 100 of example 9 Washcoat 104 can be synthesized by any suitable chemical technique known in the art, deposited on the cordierite Substrate 102 and then heat treated. The total solid loading of Washcoat 104 on Substrate 102 is of about 120 g/L. The Overcoat 106 is prepared by co-milling. Copper and cerium salts are milled with the carrier material oxide, alumina and the OSM. After milling the Overcoat 106 is deposited on a Substrate 102 previously coated with Washcoat 104. ZPGM catalyst system 100 is then heat treated, this treatment may be performed at about 300° C. to about 700° C. In some embodiments this treatment may be performed at about 550° C. The heat treatment may last from about 2 to about 6 hours. In an embodiment the treatment may last about 4 hours. The total solid loading of Overcoat 106 is 120 g/L. The ZPGM catalyst system 100 of example 9 is aged in dry air condition at 900° C. for 4 hours. After aging, a light-off test is performed under lean conditions (R=0.611), including toluene in the feed stream. The measured T50 for CO is of about 286° C. and for CO is of about 241° C.

We claim:

1. A catalytic converter comprising:
a substrate;
a washcoat on the substrate; and
an overcoat on the washcoat;
wherein the washcoat includes an oxide solid comprising least one a carrier material oxide milled with at least one catalyst;
wherein the washcoat includes a first impregnation composition that includes at least one selected from the group comprising transition metals, alkali and alkaline earth metals, cerium, lanthanum, yttrium, lanthanides, actinides, or mixtures thereof; and
wherein the first impregnation composition is absorbed by the washcoat.

2. The catalytic converter of claim 1, wherein the at least one catalyst is a zero platinum group metal (ZPGM).

3. The catalytic converter of claim 2, wherein the ZPGM is selected from the group consisting of copper, cerium, silver, tin, niobium, zirconium, lanthanum, iron, cobalt, manganese, calcium and combinations thereof.

4. The catalytic converter of claim 1, wherein the overcoat comprises at least one second catalyst.

5. The catalytic converter of claim 4, wherein the at least one second catalyst comprises a ZPGM.

6. The catalytic converter of claim 5, wherein the ZPGM is selected from the group consisting of copper, cerium, silver, tin, niobium, zirconium, lanthanum, iron, cobalt, manganese, calcium and combinations thereof.

7. The catalytic converter of claim 1, wherein the overcoat further comprises at least one oxygen storage material.

8. The catalytic converter of claim 1, wherein the oxygen storage material is selected from the group consisting of at least one of cerium, zirconium, neodymium, praseodymium, samarium, lanthanum, and yttrium.

9. The catalytic converter of claim 1, wherein the at least one catalyst comprises silver and is about 4% to about 10% by weight of the washcoat.

10. The catalytic converter of claim 1, wherein the at least one catalyst comprises silver, copper, and cerium and has suitable oxidation properties at less than about 300° Celsius.

11. The catalytic converter of claim 1, wherein the substrate is selected from the group consisting of a refractive material, a ceramic substrate, a metallic substrate, a ceramic foam, a metallic foam, a reticulated foam, and mixtures thereof.

12. The catalytic converter of claim 1, wherein the substrate comprises at least one of the group consisting of zeolites, cordierites, or mixtures thereof.

13. The catalytic converter of claim 1, wherein the particle size of the oxide solid is about 4 microns to about 10 microns.

14. A catalytic converter comprising:
a substrate;
a washcoat located on the substrate; and
an overcoat located on the washcoat;
wherein the washcoat includes an oxide solid consisting of at least one of a carrier material oxide precipitated with at least one catalyst;
wherein the washcoat includes a first impregnation composition;
wherein the first impregnation composition includes at least one selected from the group comprising transition metals, alkali and alkaline earth metals, cerium, lanthanum, yttrium, lanthanides, actinides, or mixtures thereof; and
wherein the first impregnation composition is absorbed by the washcoat.

15. The catalytic converter of claim 14, wherein the at least one catalyst is a zero platinum group metal (ZPGM).

16. The catalytic converter of claim 15, wherein the ZPGM is selected from the group consisting of copper, cerium, silver, tin, niobium, zirconium, lanthanum, iron, cobalt, manganese, calcium and combinations thereof.

17. The catalytic converter of claim 15, wherein the ZPGM is selected from the group consisting of copper, cerium, silver, tin, niobium, zirconium, lanthanum, iron, cobalt, manganese, calcium and combinations thereof.

18. The catalytic converter of claim 14, wherein the overcoat further comprises at least one oxygen storage material.

19. The catalytic converter of claim 18, wherein the oxygen storage material is selected from the group consisting of at least one of cerium, zirconium, neodymium, praseodymium, samarium, lanthanum, and yttrium.

20. The catalytic converter of claim 15, wherein the ZPGM comprises silver and is about 4% to about 10% by weight of the washcoat.

21. The catalytic converter of claim 14, wherein particle size of the oxide solid is about 4 microns to about 10 microns.
